(19) United States
(12) Patent Application Publication
(10) Pub. No.: US 2016/0308920 A1
(43) Pub. Date: Oct. 20, 2016

(54) Visual Configuration for Communication Session Participants

(71) Applicant: Microsoft Technology Licensing, LLC, Redmond, WA (US)

(72) Inventors: Devi Brunsch, Seattle, WA (US); Jason Thomas Faulkner, Seattle, WA (US); Mark Robert Swift, Mercer Island, WA (US)

(21) Appl. No.: 14/806,203

(22) Filed: Jul. 22, 2015

Related U.S. Application Data
(60) Provisional application No. 62/148,415, filed on Apr. 16, 2015.

(51) Int. Cl. H04L 29/06; H04L 29/08

(52) U.S. Cl. CPC H04L 65/403; H04L 67/24; H04L 67/141; H04L 67/22

(57) ABSTRACT

Techniques for visual configuration for communication session participants are described. According to various embodiments, a communication session is established that includes a video feed that is streamed between devices involved in the communication session. The video feed, for example, includes video images of participants in the communication session. A number of participants present at a particular device involved in the communication session is determined and used to generate instructions to other devices for visually representing video of the participants. According to various embodiments, user activity for participants in a communication session is detected and used to determine how the participants are visually represented for the communication session. For instance, users that are determined to be active in the communication session are presented visually more prominently than users that are less active.

### RELATED APPLICATION

This application claims priority to U.S. Provisional App. No. 62/148,415, filed on Apr. 16, 2015 and titled “Visual Configuration for Communication Session Participants,” the entire disclosure of which is incorporated by reference herein.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems enable users to exchange various types of media during communication sessions and may be integrated with multimodal communication systems providing different kinds of communication and collaboration capabilities. Such integrated systems are sometimes referred to as Unified Communication and Collaboration (UC&C) systems.

While modern communication systems provide for increased flexibility in communications, they also present a number of implementation challenges. For instance, a communication session between different users at different devices typically involves presenting some type of visual representation of the different users. For instance, video feeds captured at the different devices can be captured and shared among the devices participating in the communication session. Alternatively or additionally, still images (e.g., avatars) that represent users participating in the communication session can be presented. However, for a communication session involving multiple users at multiple different devices, presenting visual representations for each of the users can consume a significant amount of available display area at each of the devices. Thus, determining how to visually arrange and prioritize visual representations of different users involved in a communication session is a primary concern for modern communication systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for visual configuration for communication session participants are described. According to various embodiments, a communication session is established that includes a video feed that is streamed between devices involved in the communication session. The video feed, for example, includes video images of participants in the communication session. A number of participants present at a particular device involved in the communication session is determined and used to generate instructions to other devices for visually representing video of the participants. According to various embodiments, user activity for participants in a communication session is detected and used to determine how the participants are visually represented for the communication session. For instance, users that are determined to be active in the communication session are presented visually more prominently than users that are less active.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example implementation scenario for displaying visual representations of users in a communication session in accordance with one or more embodiments.

FIG. 3 depicts an example implementation scenario for displaying visual representations of users joining a communication session in accordance with one or more embodiments.

FIG. 4 depicts an example implementation scenario for arranging user visuals based on user activity in a communication session in accordance with one or more embodiments.

FIG. 5 depicts an example implementation scenario for arranging a multiple user visual based on user activity in a communication session in accordance with one or more embodiments.

FIG. 6 depicts an example implementation scenario for arranging a client GUI for a communication session in response to an additional participant in accordance with one or more embodiments.

FIG. 7 depicts an example implementation scenario for arranging a client GUI for a communication session for sharing content in accordance with one or more embodiments.

FIG. 8 depicts an example arrangement of a client GUI in accordance with one or more embodiments.

FIG. 9 depicts an example standing row table in accordance with one or more embodiments.

FIG. 10 is a flow diagram that describes steps in a method for specifying a visual configuration for one or more participants in a communication session accordance with one or more embodiments.

FIG. 11 is a flow diagram that describes steps in a method for presenting a user visual for one or more participants in a communication session accordance with one or more embodiments.

FIG. 12 is a flow diagram that describes steps in a method for determining a visual configuration for one or more participants in a communication session accordance with one or more embodiments.

FIG. 13 is a flow diagram that describes steps in a method for ascertaining activity for a participant in a communication session accordance with one or more embodiments.

FIG. 14 is a flow diagram that describes steps in a method for ascertaining an activity level for an active participant in a communication session in accordance with one or more embodiments.

FIG. 15 illustrates an example system and computing device as described with reference to FIG. 1, which are configured to implement embodiments of techniques described herein.

### DETAILED DESCRIPTION

### Overview

Techniques for visual configuration for communication session participants are described. In at least some implementations, a communication session refers to a real-time exchange of communication media between different communication endpoints. Examples of a communication session include a Voice over Internet Protocol (VoIP) call, a video call, text messaging, a file transfer, content sharing, and/or combinations thereof. In at least some embodiments, a communication session represents a Unified Communication and Collaboration (UC&C) session.

According to various implementations, a communication session is established that includes a video feed that is streamed between devices involved in the communication session. The video feed, for example, includes video images of participants in the communication session. A number of participants present at a particular device involved in the communication session is determined and used to generate instructions to other devices for visually representing video of the participants. For instance, if a single user is detected at the particular device, the instructions specify that the user is to be presented according to a single user visualization. If multiple users are detected, the instructions specify that the users are to be presented according to a multiple user visualization.

According to various implementations, user activity for participants in a communication session is detected and used to determine how the participants are visually represented for the communication session. For instance, users that are determined to be active in the communication session are presented visually more prominently than users that are less active, e.g., passive.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

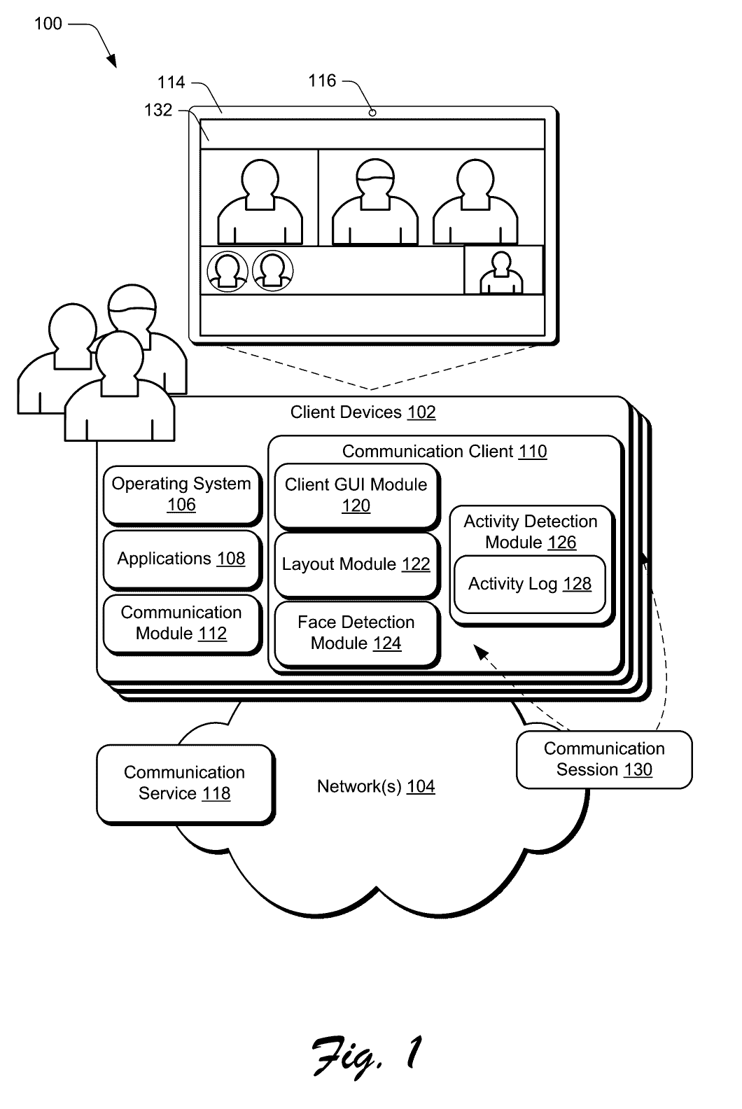

FIG. 1 is an illustration of an environment 100 in an example implementation that is operable to employ techniques for visual configuration for communication session participants described herein. Generally, the environment 100 includes various devices, services, and networks that enable communication via a variety of different modalities. For instance, the environment 100 includes client devices 102 connected to a network 104. The client devices 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), a mixed reality device (e.g., a virtual reality (VR) headset), and so forth. For purposes of the following discussion attributes of a single client device 102 are discussed, but it is to be appreciated that the discussed attributes similarly apply across the different instances of the client devices 102.

The network 104 is representative of a network that provides the client device 102 with connectivity to various networks and/or services, such as the Internet. The network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 104 represents different interconnected wired and wireless networks.

The client device 102s include a variety of different functionalities that enable various activities and tasks to be performed. For instance, the client device 102 includes an operating system 110, applications 108, a communication client 110, and a communication module 112. Generally, the operating system 110 is representative of functionality for abstracting various system components of the client device 102, such as hardware, kernel-level modules and services, and so forth. The operating system 110, for instance, can abstract various components of the client device 102 to the applications 108 to enable interaction between the components and the applications 108.

The applications 108 represent functionalities for performing different tasks via the client device 102. Examples of the applications 108 include a word processing application, a spreadsheet application, a web browser, a gaming application, and so forth. The applications 108 may be installed locally on the client device 102 to be executed via a local runtime environment, and/or may represent portals to remote functionality, such as cloud-based services, web apps, and so forth. Thus, the applications 108 may take a variety of forms, such as locally-executed code, portals to remotely hosted services, and so forth.

The communication client 110 is representative of functionality to enable different forms of communication via the client device 102. Examples of the communication client 110 include a voice communication application (e.g., a VoIP client), a video communication application, a messaging application, a content sharing application, a unified communication & collaboration (UC&C) application, and combinations thereof. The communication client 110, for instance, enables different communication modalities to be combined to provide diverse communication scenarios.

The communication module 112 is representative of functionality for enabling the client device 102 to communicate data over wired and/or wireless connections. For instance, the communication module 112 represents hardware and logic for data communication over the network 104 via a variety of different wired and/or wireless technologies and protocols.

The client device 102 further includes a display device 114 display device 114 and a camera 116. The display device 114 generally represents functionality for visual output for the client device 102. Additionally, the display device 114 represents functionality for receiving various types of input, such as touch input, pen input, and so forth.

The camera 116 is representative of functionality to capture and record visual images, such as still images, video, and so on. The camera 116 includes various image capture components, such as apertures, lenses, mirrors, prisms, electronic image sensors, and so on.

In at least some implementations, the communication client 110 represents an interface to a communication service 118. Generally, the communication service 118 is representative of a service to perform various tasks for management of communication between the different client devices 102. The communication service 118, for instance, can manage initiation, moderation, and termination of communication sessions between the communication clients 110 of the different client devices 102.

The communication service 118 maintains a presence across many different networks and can be implemented according to a variety of different architectures, such as a cloud-based service, a distributed service, a web-based service, and so forth. Examples of the communication service 118 include a VoIP service, an online conferencing service, a UC&C service, and so forth.

Further to techniques for visual configuration for communication session participants described herein, the communication client 110 includes a client graphical user interface (GUI) module 120, a layout module 122, a face detection module 124, and an activity detection module 126. The client GUI module 120 is representative of functionality to generate and output a GUI for the communication client 110. The layout module 122 is representative of functionality to perform various visual arrangement and layout calculations for the client GUI module 120. For instance, as detailed below, the layout module 122 receives various state information for a communication session, and generates visual arrangement data that specifies how visual attributes of a GUI for the communication session are to be visually arranged.

The face detection module 124 is representative of functionality to detect images of faces in incoming video, such as video captured from the camera 116 and/or video data received from other devices. In at least some implementations, the face detection module 124 quantifies a number of different face images detected in a particular video feed, and communicates this information to other functionalities. For instance, the face detection module 124 communicates a number of face images detected in a particular video feed to the layout module 122. The layout module 122 uses this number to determine a visual layout for displaying the particular video feed, such as an amount of screen space to allot for displaying the video feed.

The activity detection module 126 is representative of functionality to detect various types of activity during a communication session, and to categorize and/or tag participants in the communication session based on their respective activity levels. For instance, a participant that frequently speaks during a communication session such that the activity detection module 126 detects frequent voice signal in the participant's media stream, the activity detection module 126 tags the participant as an active participant. Further, if a different participant rarely speaks during a communication session such that little or no voice signal is detected by the activity detection module 126 in the participant's media stream, the participant is tagged as a passive participant. The activity detection module 126 maintains an activity log 128 that stores activity information for different participants in communication sessions. The activity log 128, for instance, includes user identifiers for different individual participants, and includes activity flags that specify whether the individual participants are active participants or passive participants. Further, the activity log 128 may include activity scores for active participants that differentiate more active participants from less active participants. The activity detection module 126 provides this information to different entities and functionalities to inform various decisions pertaining to a communication session.

For example, the activity detection module 126 communicates activity tags for different participants in a communication session to the layout module 122, and the layout module 122 uses this activity information to determine a visual layout of a GUI for the communication session. For instance, and as detailed below, a visual representation of an active participant in a communication session is displayed more prominently (e.g., larger) than a visual representation of a passive participant. Further, changes in activity levels during a communication session may occur such that participants are dynamically evaluated by the activity detection module 126 for their activity level, and can be retagged should their activity levels change.

While the various modules of the communication client 110 are depicted as being implemented on the client device 102, it is to be appreciated that in some additional or alternative implementations, functionality of one or more of the modules may be partially or wholly implemented via a network-based service, such as the communication service 118. For instance, the communication service 118 may utilize data captured from media streams of a communication session to make layout decisions for rendering GUIs at devices involved in the communication session.

The environment 100 further depicts that a communication session 130 is in progress between different instances of the client devices 102. The communication session 130, for instance, represents a real-time exchange of voice and video between the different client devices 102. As part of the communication session 130, a client GUI 132 is displayed on the display device 114. Generally, the client GUI 132 includes visual representations of different attributes of the communication session 130. For instance, the client GUI 132 includes visual representations of participants in the communication session 130, such as users of the different client devices 102. As further detailed below, techniques for visual configuration for communication session participants described herein are employed to determine a visual arrangement for the client GUI 132 based on various factors, such as a total number of participants in the communication session, a number of participants present at a particular location, activity levels for the individual participants, and so forth.

Having described an example environment in which the techniques described herein may operate, consider now a discussion of some example implementation scenarios for visual configuration for communication session participants in accordance with one or more embodiments.

Example Implementation Scenario

The following section describes some example implementation scenarios for visual configuration for communication session participants in accordance with one or more implementations. The implementation scenarios may be implemented in the environment 100 discussed above, and/or any other suitable environment.

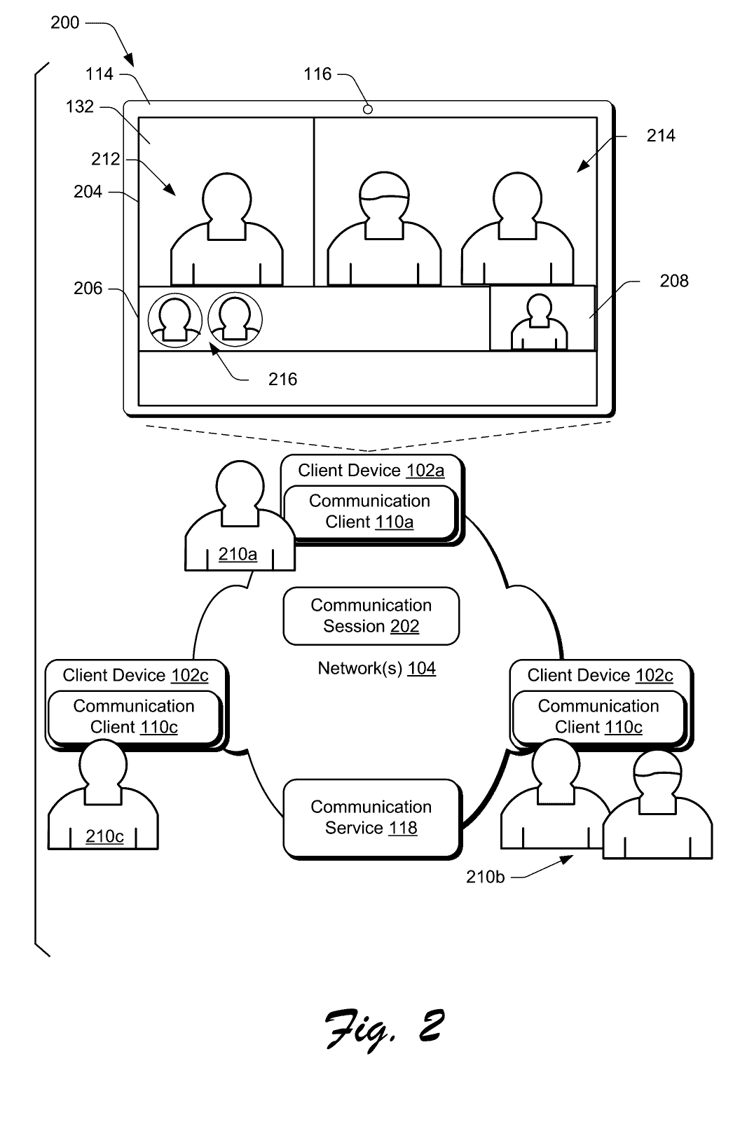

FIG. 2 depicts an example implementation scenario 200 for displaying visual representations of users in a communication session in accordance with one or more implementations. The scenario 200 includes various entities and components introduced above with reference to the environment 100.

In the scenario 200, a communication session 202 is in progress between a client device 102a, a client device 102b, and a client device 102c. Generally, the client devices 102a-102c represent different instances of the client devices 102 introduced above. The communication session 202 represents an exchange of different communication media between the client devices 102a-102c, such as audio, video, files, media content, and/or combinations thereof. In this particular example, the communication session 202 involves a real-time exchange of voice data and video data between the client devices 102a-102c over the network 104. According to various implementations, the communication session 202 is managed by the communication service 118.

As part of the communication session 202, the display device 114 for the client device 102a displays the client GUI 132, which represents a GUI for the communication client 110. Displayed within the client GUI 132 are visual representations of participants (i.e., users) involved in the communication session. For instance, the client GUI 132 includes a standing row 204, a sitting row 206, and a preview window 208 that each display different visual representations (“user visuals”) of participants in the communication session.

According to various implementations, the standing row 204 represents a region of the client GUI 132 that is initially populated with user visuals. For instance, during initiation of the communication session 202, the standing row 204 is populated with user visuals for the initial users to join the communication session 202. When the number of user visuals populated to the standing row reaches a threshold number, subsequent user visuals are populated to the sitting row 206. As further detailed below, while the communication session 202 is in progress, visual configuration of the standing row 204 and the sitting row 206 is determined at least in part based on user activity during the communication session. For instance, user visuals presented in the standing row 204 are larger than user visuals presented in the sitting row 206, and thus the standing row 204 may be reserved for user visuals for the most active users. The standing row 204, for instance, represents an active region of the client GUI 132. Those users that are less active and/or passive during the communication session 202 are represented in the sitting row 206. The sitting row 206, for example, represents a passive region of the client GUI 132.

The preview window 208 is populated with a user visual for a user 210a present at the client device 102a. For instance, a video feed from the camera 116 is presented within the preview window 208 as a notification to the user 210a that video feed from the camera 116 is being streamed to other client devices participating in the communication session 202.

According to techniques for visual configuration for communication session participants described herein, user visuals presented in the client GUI 132 are configured based on a number of users detected at the different client devices 102. For instance, the face detection module 124 at the client device 102c inspects a video feed captured at the client device 102c and detects a single face image for a user 210c in the video feed. Generally, the face detection module 124 may employ any suitable facial recognition technique. Thus, as part of the communication session 202, a communication client 110c of the client device 102c instructs a communication client 110a of the client device 102a to render video feed from the client device 102c according to a single user scenario. For instance, the communication client 110c notifies the communication client 110a that a single user image is present in video feed from the client device 102c. Thus, the communication client 110a crops the video feed from the client device 102c and presents the video feed as a single user visual 212 within the standing row 204. As depicted, the single user visual 212 includes a single visual representation of the user 210c.

The single user visual 212, for example, is generated by cropping a larger video frame received from the client device 102c. For instance, video feed received from the client device 102c as part of the communication session 202 has an aspect ratio that is different than that of the single user visual 212. In one example implementation, video feed is received from the client device 102c with a 16:9 aspect ratio. However, in response to ascertaining that a single user is present at the client device 102c, the layout module 122 for the client device 102a crops the video feed for display in the client GUI 132, such as to a 1:1 aspect ratio.

Continuing with the scenario 200, the face detection module 124 at the client device 102b inspects video feed captured at the client device 102b and detects multiple face images (e.g., two face images) for users 210b in the video feed. Thus, as part of the communication session 202, a communication client 110b of the client device 102b instructs the communication client 110a to render video feed from the client device 102b according to a multiple user scenario. For instance, the communication client 110b notifies the communication client 110a that a multiple user images are present in video feed from the client device 102b. Accordingly, the communication client 110a presents the video feed from the client device 102b as a multiple user visual 214 within the standing row 204. As depicted, the multiple user visual 214 includes a visual representation of the multiple users 210b.

In at least some implementations, the multiple user visual 214 is presented in an aspect ratio in which it is received in a video feed from the client device 102b, such as 16:9. Alternatively, the video feed from the client device may be cropped to enable the multiple user visual 214 to be fit within the standing row 204, while maintaining visual representations of the users 210b within the multiple user visual 214.

As further depicted in the scenario 200, the sitting row 206 includes user visuals 216 for other participants in the communication session 202. The user visuals 216, for example, represent users that joined the communication session 202 later than those represented in the standing row 204. Alternatively or additionally, the user visuals 202 represent users that are less active than those represented in the standing row 204.

According to various implementations, graphics for the various user visuals may be generated in various ways. For instance, real-time video feeds can be captured via cameras at the different client devices 102 and streamed as part of the communication session 202. Alternatively, a particular user visual may include a static image, such as an avatar and/or snapshot that represents a particular user. For instance, if a video feed at a particular client device 102 is not active and/or has poor quality, an avatar for a user of the client device is presented as a user visual. Alternatively or additionally, a user may select a snapshot control to manually capture a snapshot that is used as a user visual.

While the scenario 200 is discussed with reference to the displaying user visuals on the client device 102a, it is to be appreciated that similar logic may be applied to arranging and displaying user visuals on other client devices involved in the communication session, e.g., the client devices 102b, 102c.

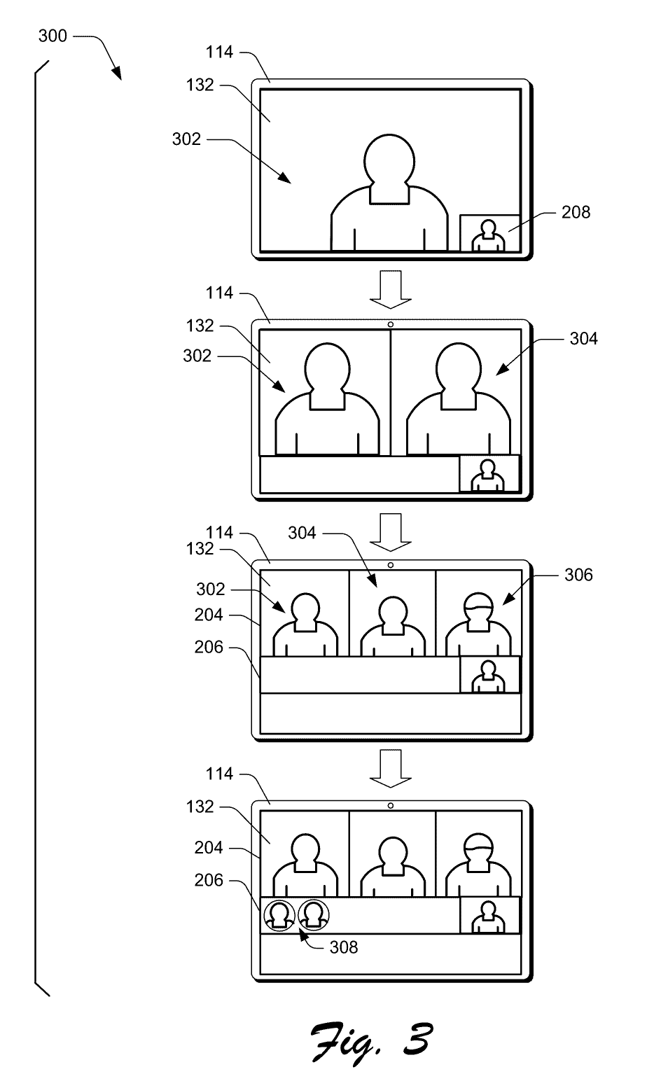

FIG. 3 depicts an example implementation scenario 300 for displaying visual representations of users joining a communication session in accordance with one or more implementations. The scenario 300 includes various entities and components introduced above with reference to the environment 100.

In the upper portion of the scenario 300, the client GUI 132 is displayed on the display device 114. Presented within the client GUI 132 is a user visual 302 and a preview window 208 that are presented for a communication session. Generally, the upper portion of the scenario 300 represents a scenario where two users have joined a communication session, i.e., a user represented by the user visual 302, and another user represented in the preview window 208. As depicted, when only two users are connected for a communication session, the user visual 302 is displayed as a full-window and/or full-screen visual. Further, the preview window 208 is presented as an inset to the user visual 302. While the user visual 302 is depicted with a single user, similar logic may be applied for multiple users at a single location/device such that the multiple users are depicted within the user visual 302.

Proceeding to the next portion of the scenario 300, a further user joins the communication session, and thus the user visual 302 is reduced in size to accommodate a user visual 304 for the further user. For instance, video feed for the different users is cropped such that the user visuals 302, 304 are of equal size and/or aspect ratio within the client GUI 132. Further, notice that the preview window 208 is presented in a region of the client GUI 132 outside of (e.g., beneath) the user visuals 302, 304.

Continuing to the next portion of the scenario 300, yet another user joins the communication session. Accordingly, the user visuals 302, 304 are reduced in size and/or aspect ratio to accommodate a user visual 306 for the incoming user. Thus, the user visuals 302-306 are presented as part of a standing row 204 for the client GUI 132, and a sitting row 206 is presented within the client GUI 132.

Proceeding to the lower portion of the scenario 300, further users join the communication session, and thus user visuals 308 for the further users are populated to the sitting row 206. For instance, the standing row 204 is consider to be at a maximum visual capacity such that visuals for further users are populated to the sitting row 206. As further discussed below, reconfiguration of the standing row 204 and the sitting row 206 can occur based on differences in activity levels for users participating in the communication session.

Thus, the scenario 300 illustrates that user visuals are populated to the client GUI 132 to maximize the size of the user visuals while allocating space equally within the standing row 204 until the standing row 204 is at maximum visual capacity. Further, once the standing row 204 is at maximum visual capacity, additional user visuals are populated to the sitting row 206.

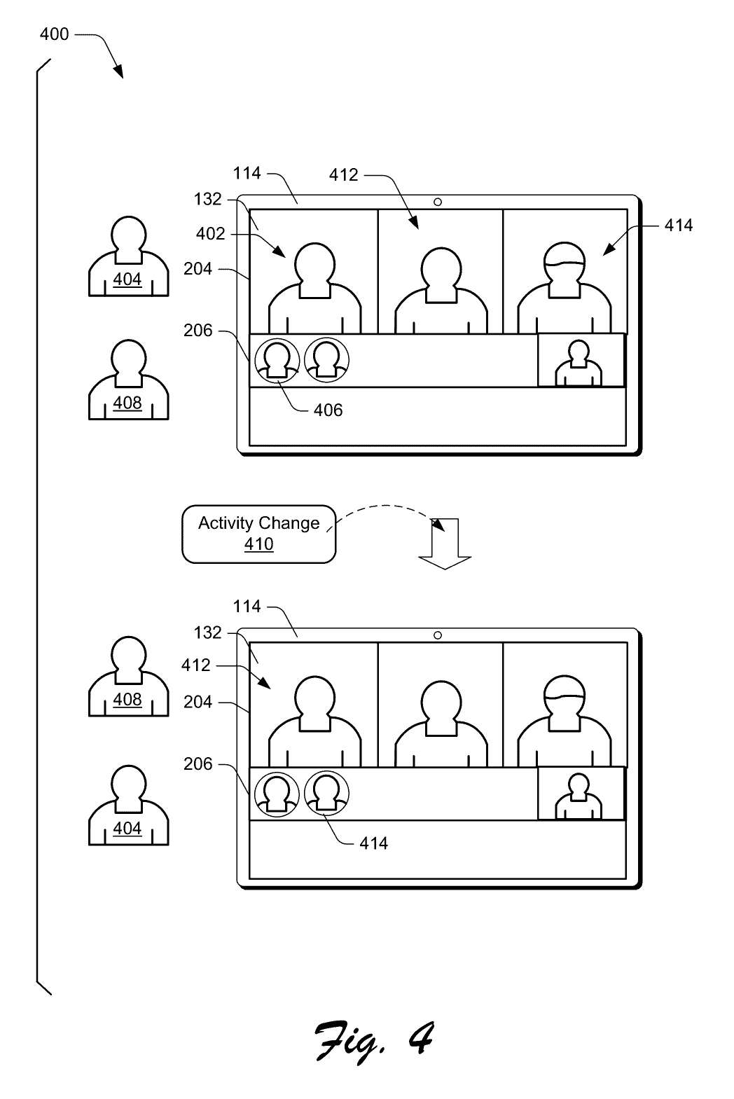

FIG. 4 depicts an example implementation scenario 400 for arranging user visuals based on user activity in a communication session in accordance with one or more implementations. The scenario 400 includes various entities and components introduced above with reference to the environment 100, and in at least some implementations represents an extension and/or variation of one or more of the scenarios 200, 300 described above.

The upper portion of the scenario 400 includes the client GUI 132 displayed on the display device 114 and with the standing row 204 and the sitting row 206 populated with user visuals for users participating in a communication session. As discussed above, the standing row 204 and the sitting row 206 can be populated with user visuals based on an order in which respective users join the communication session. Alternatively or additionally, the standing row 204 and the sitting row 206 can be populated with user visuals based on activity levels for respective users. For instance, the activity detection module 126 quantifies activity levels for participants in the communication session based on voice data detected in media streams from the different participant's respective client devices. Generally, activity level for a participant can be quantified in various ways, such as based on an aggregate amount of voice input detected from the participant, how recently voice data from the participant is detected, how frequently voice data from the participant is detected, and so forth.

Further to the scenario 400, the standing row 204 is populated with user visuals for the most active participants in the communication session. For example, the activity detection module 126 determines relative activity levels the participants in the communication session, and notifies the layout module 122 of the relative activity levels. The layout module 122 then utilizes the activity information to determine which user visuals are to be populated to the standing row 204, and which are to be populated to the sitting row 206. In this particular scenario, user visuals for the three most active participants are populated to the standing row 204 including a user visual 402 for an active participant 404. Further, user visuals for the remaining participants are populated to the sitting row 206 including a user visual 406 for a less active participant 408.

Proceeding to the lower portion of the scenario 400, an activity change 410 is detected with reference to the participant 408. For instance, the activity detection module 126 detects that an activity level for the participant 408 increases, such as based on an increase in voice data detected from the participant 408. Thus, the activity detection module 126 provides the layout module 122 with updated activity information including an indication of the increase in the activity level for the participant 408. Based on the updated activity information, the layout module 122 identifies that the participant 404 is the least active participant currently represented in the standing row 204. Accordingly, the layout module 122 promotes the participant 408 to the standing row 204, and demotes the participant 404 to the sitting row 206. Thus a user visual 412 for the participant 408 replaces the user visual 402 in the standing row 204, and a user visual 414 is presented in the sitting row 206 for the user 404.

Further to the scenario 400, activity levels for the different participants are continually monitored and quantified such that changes to the standing row 204 and the sitting row 206 can be implemented in response to changes in activity level. For instance, a promotion to the standing row 204 and/or a demotion to the sitting row 206 is implemented in response to a further change in activity level for a participant in the communication session.

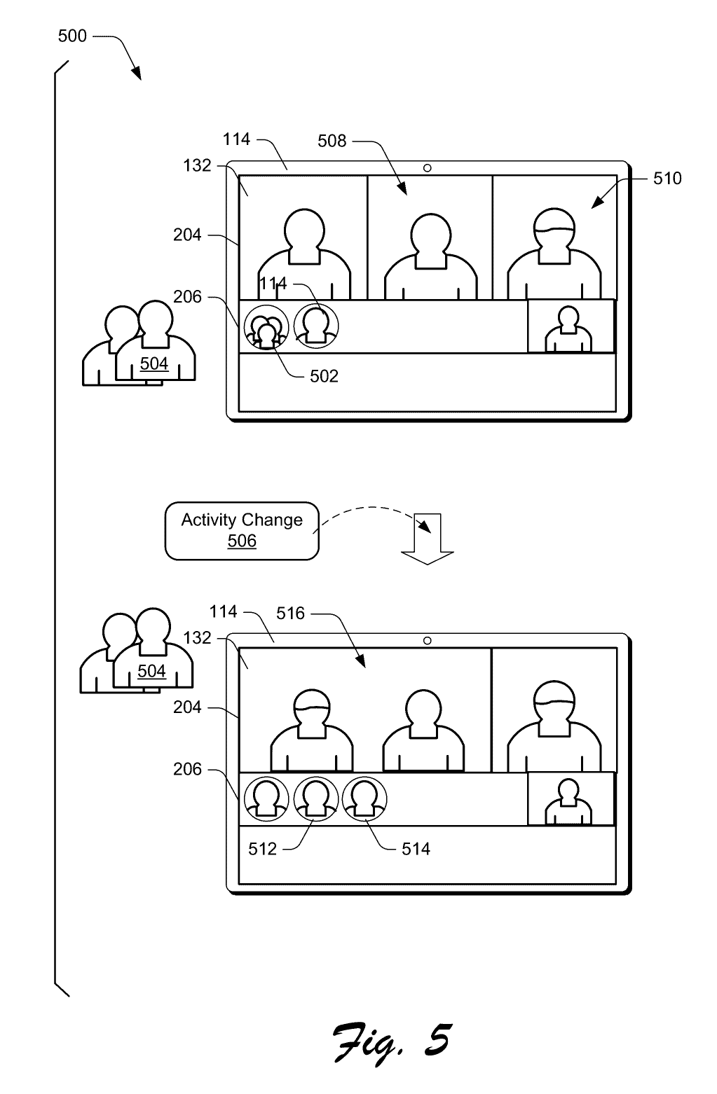

FIG. 5 depicts an example implementation scenario 500 for arranging a multiple user visual based on user activity in a communication session in accordance with one or more implementations. The scenario 400 includes various entities and components introduced above with reference to the environment 100, and in at least some implementations represents an extension and/or variation of one or more of the scenarios 200-400 described above.

The upper portion of the scenario 500 includes the client GUI 132 displayed on the display device 114 and with the standing row 204 and the sitting row 206 populated with user visuals for users participating in a communication session. Generally, the standing row 204 and the sitting row 206 are populated based on various parameters, such as participant join order and/or activity level for the communication session.

The sitting row 206 includes a user visual 502 that represents multiple participants 504 that are present at a particular client device that is connected to the communication session. The face detection module 124, for instance, detects the participants 504 at the client device, and notifies the layout module 122 that multiple participants 504 are present at the client device. Accordingly, the layout module 122 uses the user visual 502 to represent the participants 504 in the sitting row 206.

Continuing to the lower portion of the scenario 500, an activity change 506 is detected with reference to the participants 504. For instance, the activity detection module 126 detects an increase in voice activity from the participants 506, such as by detecting voice data that exceeds a voice activity threshold in a media feed from the participants 504. Accordingly, the activity detection module 126 communicates updated activity information to the layout module 122, including an indication that the participants 504 are active participants in the communication session. Based on the updated activity information, the layout module 122 ascertains that the participants 504 are to be promoted to the standing row 204. Further, the layout module 122 determines that a multiple user visual is to be used to represent the participants 504. For instance, a face detection module 124 at a client device that captures video feed of the participants 504 notifies the layout module 122 that the video feed is to be rendered as a multiple user visual.

Based on the updated activity information from the activity detection module 126, the layout module ascertains that participants represented by user visuals 508, 512 are the two least active participants represented in the standing row 204. Accordingly, the layout module 122 demotes the least active participants to the sitting row 206 and promotes the participants 504 to the standing row 204. Thus, user visuals 512, 514 for the demoted participants are populated to the sitting row 206. Further, a multiple user visual 516 is populated to the standing row 204 to replace the user visuals 508, 510. The multiple user visual 516, for example, includes a video feed representing the multiple users 504.

According to various implementations, if user activity for the participants 504 decreases and/or if user activity for one or more of the participants represented in the sitting row 206 increases, the participants 504 may be demoted to the sitting row 206 such that the two most active participants represented in the sitting row 206 are promoted and represented in the standing row 204 to replace the multiple user visual 516.

Thus, the scenario 500 illustrates that techniques described herein can be employed to configure the client GUI 132 based on activity detected with reference to multiple users detected during a communication session.

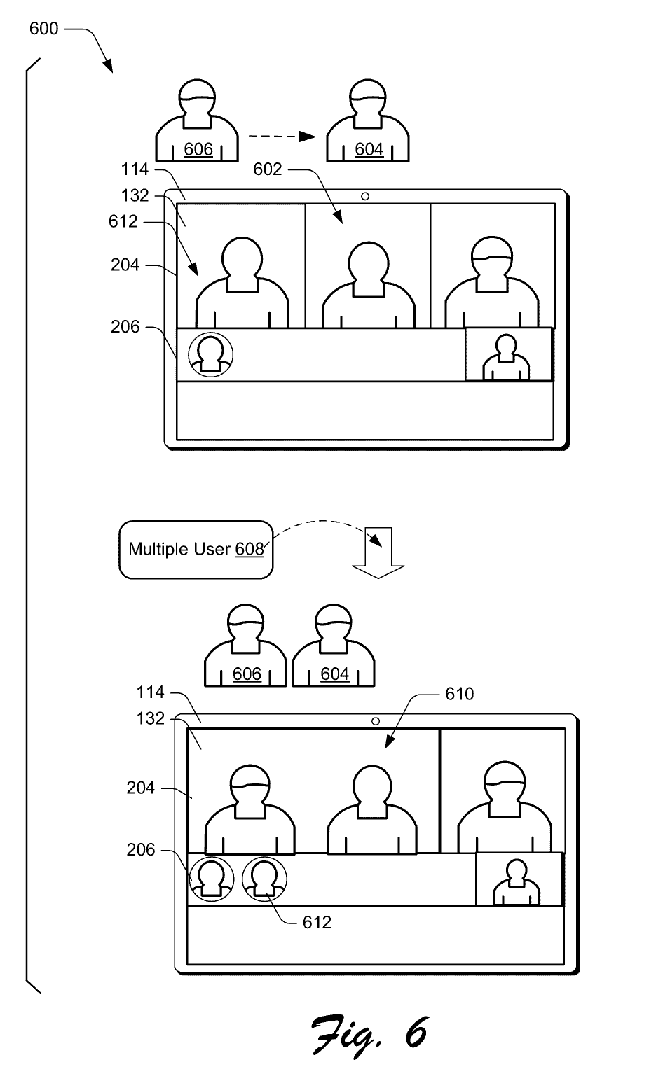

FIG. 6 depicts an example implementation scenario 600 for arranging a client GUI for a communication session in response to an additional participant in accordance with one or more implementations. The scenario 600 includes various entities and components introduced above with reference to the environment 100, and in at least some implementations represents an extension and/or variation of one or more of the scenarios 200-500 described above.

The upper portion of the scenario 600 includes the client GUI 132 displayed on the display device 114 and with the standing row 204 and the sitting row 206 populated with user visuals for users participating in a communication session. Generally, the standing row 204 and the sitting row 206 are populated based on various parameters, such as participant join order and/or activity level for the communication session.

The standing row 204 includes a single user visual 602 for a participant 604 of the communication session. For instance, when the participant 604 joined the communication session, the participant 604 was detected as a single participant, e.g., by the face detection module 124. Thus, the layout module 122 was instructed to render a video feed for the participant 604 according to a single user scenario.

Further to the scenario 600, a participant 606 joins the participant 604 for the communication session. For instance, the participant 606 enters a room (e.g., a conference room, an office, and so forth) in which the participant 604 is situated and while the communication session is in progress. Accordingly, the face detection module 124 detects that an additional user is present in video feed that includes the participant 604, and generates a multiple user notification 608. In response to the multiple user notification 608, the layout module 122 populates a multiple user visual 610 that includes video images of the participants 604, 606 to the standing row 204. To make room for the multiple user visual 610, the layout module 122 demotes a least active participant from the standing row 204 to the sitting row 206. Thus, a user visual 612 for the least active participant is removed from the standing row 204, and a user visual 614 for the least active participant is populated to the sitting row 206.

Accordingly, the scenario 600 illustrates that changes in a number of users participating in a communication session at a particular location can cause a change in configuration of the client GUI 132, such as to accommodate additional users. While the scenario 600 is discussed with reference to detecting additional users, it is to be appreciated that similar logic may be applied to detect fewer users. For instance, consider the scenario 600 in reverse such that the participant 606 leaves a location at which the user 604 is participating the communication session. In such a scenario the face detection module 124 detects that a number of participants at the location is reduced, and sends a notification to the layout module 122 indicating that a number of participants at the location has changed, e.g., is reduced to one participant. Accordingly, the layout module 122 reconfigures the user representation for the participant 604 to the single user visual 602 that includes the user 604. Further, a most active participant from the sitting row 206 is promoted to the standing row.

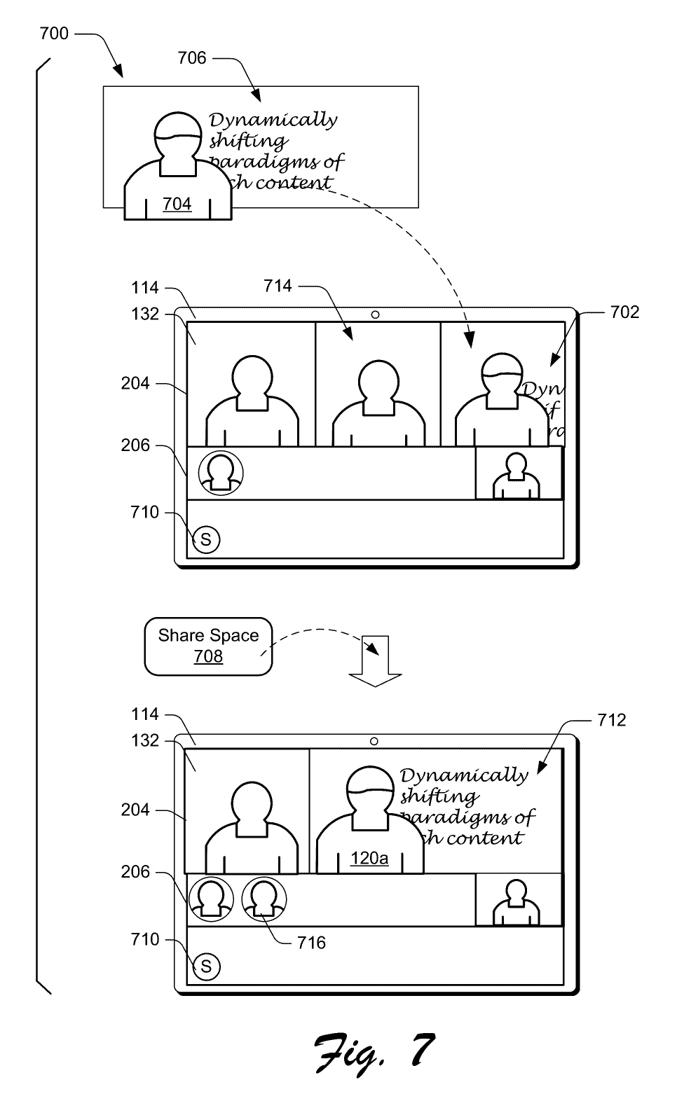

FIG. 7 depicts an example implementation scenario 700 for arranging a client GUI for a communication session for sharing content in accordance with one or more implementations. The scenario 700 includes various entities and components introduced above with reference to the environment 100, and in at least some implementations represents an extension and/or variation of one or more of the scenarios 200-600 described above.

The upper portion of the scenario 700 includes the client GUI 132 displayed on the display device 114 and with the standing row 204 and the sitting row 206 populated with user visuals for users participating in a communication session. Generally, the standing row 204 and the sitting row 206 are populated based on various parameters, such as participant join order and/or activity level for the communication session. The sitting row 206 includes a single user visual 702 for a participant 704 in the communication session.

Further to the scenario 700, the participant 704 has content 706 to share as part of the communication session. The content 706, for instance, represents content that is physically present at the participant 704's location, such as content on a whiteboard and/or other physical medium. Alternatively or additionally, the content 706 represents digital content that the participant 704 wishes to share, such as content on a desktop user interface of the participant 704, an electronic content file stored in a file storage location, and so forth.

Accordingly, and proceeding to the lower portion of the scenario 700, the participant 704 generates a share space request 708 requesting additional display space within the client GUI 132 to enable the content 706 to be shared with other participants in the communication session. For instance, the participant 704 selects a share control 710 at their respective instance of the client GUI 132. In response to the share space request 708, the participant 704 is provided with a share frame 712 within the standing row 204. For instance, the single user visual 702 is expanded to the share frame 712. Thus, the content 706 is viewable within the share frame 712. The participant 706 may interact with the content 706, and such interaction is viewable in the share frame 712 by other participants in the communication session.

To provide space for the share frame 712, a least active participant from the standing row 204 is demoted to the sitting row 206. For instance, a user visual 714 in the standing row 204 for the least active participant is removed, and a user visual 716 for the least active participant is populated to the sitting row 206.

According to one or more implementations, when the participant 704 is finished sharing the content 706, the participant 704 may indicate that the participant 704 is finished sharing. For instance, the participant 704 may again select the sharing control 710. In response, the sharing frame 712 is removed and the participant is represented via the single user visual 702. For instance, returning to the upper portion of the scenario 700, the participant 704 is represented via the single user visual 702 in the standing row 204. Further, a most active participant from the sitting row 206 is promoted to the standing row.

Thus, the scenario 700 illustrates that a sharing space can be allotted to enable a user to share content during a communication session. Further, allotting the sharing space includes reconfiguring the client GUI 132 based on user activity for participants involved in the communication session.

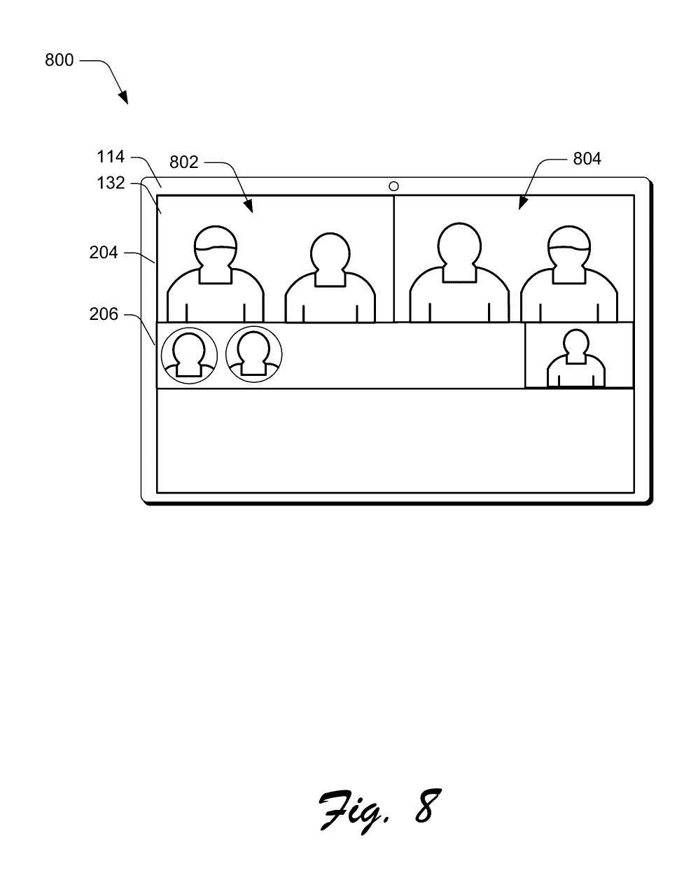

FIG. 8 depicts an example arrangement of the client GUI 132 displayed on the display device 114, including the standing row 204 and the sitting row 206. In this particular example, the standing row 204 is populated with two multiple user visuals, i.e., a multiple user visual 802 and a multiple user visual 804. Generally, the multiple user visuals 802, 804 are generated using video feeds captured at locations at which participants represented in the multiple user visuals 802, 804 are located. For instance, participants depicted within both of the multiple user visuals 802, 804 are determined to be the most active participants in a communication session. Thus, video feeds that include the participants are visually sized within the client GUI 132 to enable the multiple user visuals 802, 804 to be presented together. Further, the sitting row 206 is populated with user visuals for other participants in the communication session, e.g., for participants that are determined to be less active than those depicted in the multiple user visuals 802, 804.

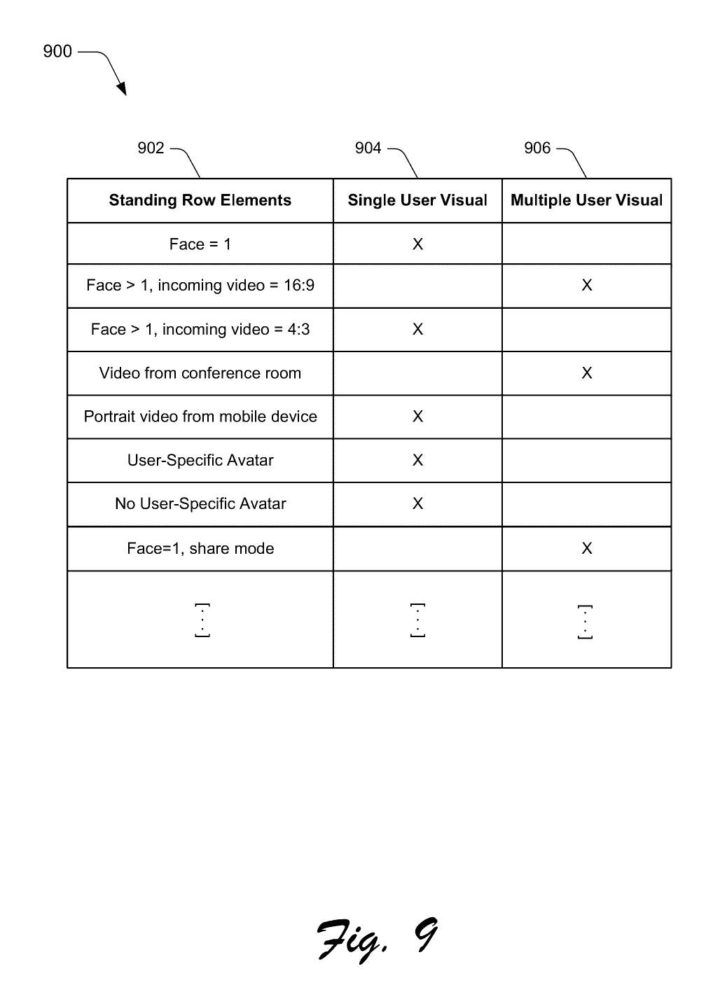

FIG. 9 depicts an example standing row table 900 in accordance with one or more implementations. Generally, the standing row table 902 specifies configurations for different user visuals to be applied during a communication session. The standing row table 904 includes an elements column 902, a single user visual column 904, and a multiple user visual column 906. Generally, the elements column 902 identifies different possible elements received in an incoming media stream during a communication session. The single user visual column 904 corresponds to a visual size (e.g., aspect ratio) for a single user visual. For instance, the single user visual column 904 corresponds to a 1:1 aspect ratio. The multiple user visual column corresponds to a visual size for a multiple user visual. For instance, the multiple user visual column 906 corresponds to a 16:9 aspect ratio.

The standing row table 900 specifies that if a single face is detected in a video stream, a single user visual is to be used to present the video stream in a standing row. If more than one face is detected in a video stream and the video stream has a wide aspect ratio (e.g., 16:9), a multiple user visual is to be used to present the video stream in a standing row. If more than one face is detected in a video stream and the video stream has a narrow aspect ratio (e.g., 14:9), a single user visual is to be used to present the video stream in a standing row. If a video stream is received from a conference room or other multi-user space, the video stream is to be presented in a multiple user visual.

If the video stream is generated in a portrait mode at a mobile device (e.g., a tablet, a mobile phone, and so forth), the video stream is to be presented in a single user visual. If a standing row participant is represented via a user-specific avatar (e.g., a still image instead of a live vide stream), the standing row participant is to be represented by populating the user-specific avatar to a single user visual. If there is no user-specific avatar or video feed for a standing row participant, the participant is to be represented via a placeholder single user visual. If a single face is detected in a video stream and a share mode is active (e.g., in response to a share request from a participant), a multiple user visual is to be used to present the video stream in a standing row.

Thus, the standing row table 900 specifies different logic for representing different configurations of participants in a communication session. These particular element configurations and visual representations are presented for purpose of example only, and it is to be appreciated that a wide variety of different elements and visual representations may be employed in accordance with techniques described herein.

Having discussed some example implementation scenarios, consider now a discussion of some example procedures in accordance with one or more embodiments.

Example Procedures

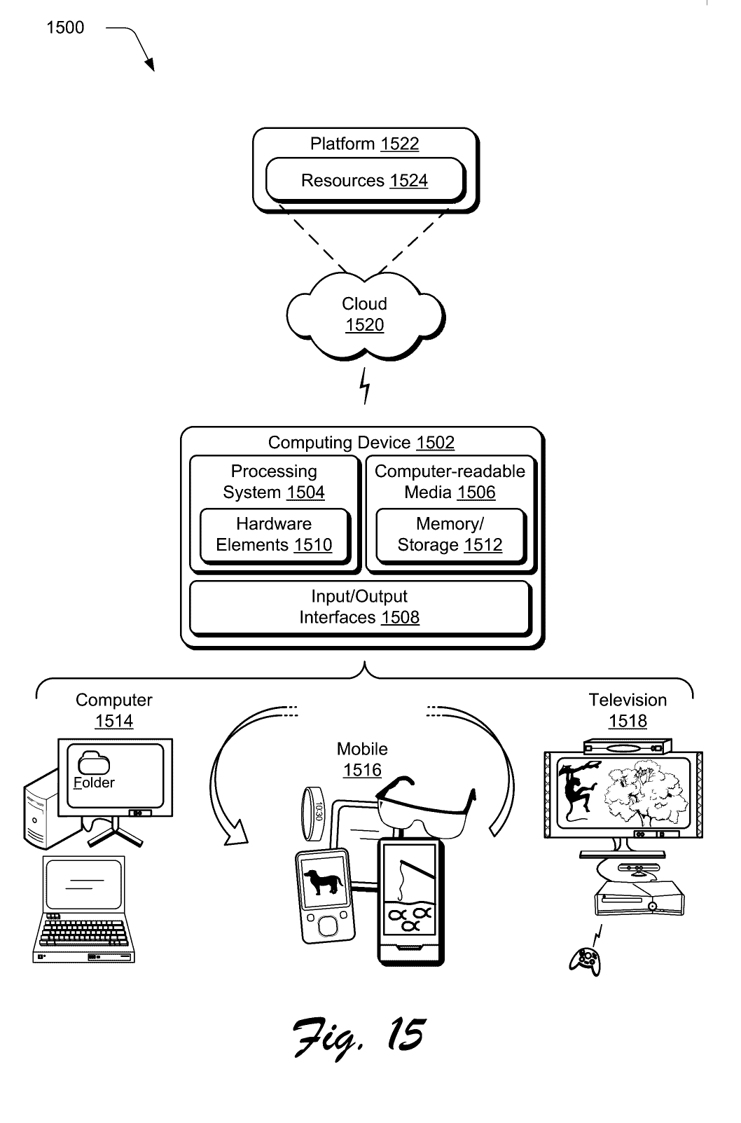

The following discussion describes some example procedures for visual configuration for communication session participants in accordance with one or more embodiments. The example procedures may be employed in the environment 100 of FIG. 1, the system 1500 of FIG. 15, and/or any other suitable environment. The procedures, for instance, represent example procedures for implementing the implementation scenarios described above. In at least some implementations, the steps described for the various procedures are implemented automatically and independent of user interaction. According to various implementations, the procedures may be performed locally (e.g., by a communication client 110 at a client device 102) and/or at a network-based service, such as the communication service 118.

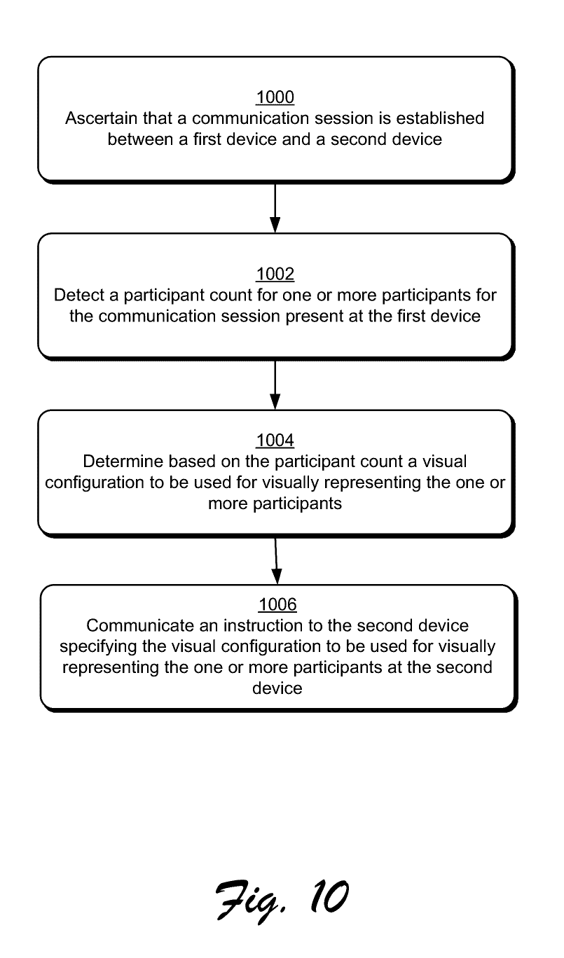

FIG. 10 is a flow diagram that describes steps in a method in accordance with one or more implementations. The method describes an example procedure for specifying a visual configuration for one or more participants in a communication session in accordance with one or more implementations.

Step 1000 ascertains that a communication session is established between a first device and a second device. A communication client 110, for instance, initiates a communication session with another communication client 110, or joins an existing communication session. Further, the client GUI module 120 generates a client GUI for the communication session.

Step 1002 detects a participant count for one or more participants for the communication session present at the first device. The participant count, for instance, is detected via video data captured at the first device, such as from a video feed captured by the camera 116 at the first device. In at least some implementations, the face detection module 124 determines the participant count by ascertaining a number of different faces detected via facial recognition processing of the video data.

Step 1004 determines based on the participant count a visual configuration to be used for visually representing the one or more participants. The face detection module 124, for instance, communicates the participant count to the layout module 122. Based on the participant count, the layout module 122 determines the visual configuration. For example, if the participant count=1, the visual configuration is determined as a single user visual for representing the single participant. If the participant count>1, the visual configuration is determined as a multiple user visual for representing the multiple participants.

Step 1006 communicates an instruction to the second device specifying the visual configuration to be used for visually representing the one or more participants at the second device. A communication client 110 at the first device, for instance, communicates the instruction to a communication client 110 at the second device. Thus, the communication client 110 at the second device may utilize the instruction to cause a visual representation of the one or more participants to be displayed at the second device based at least in part on the visual configuration specified in the instruction.

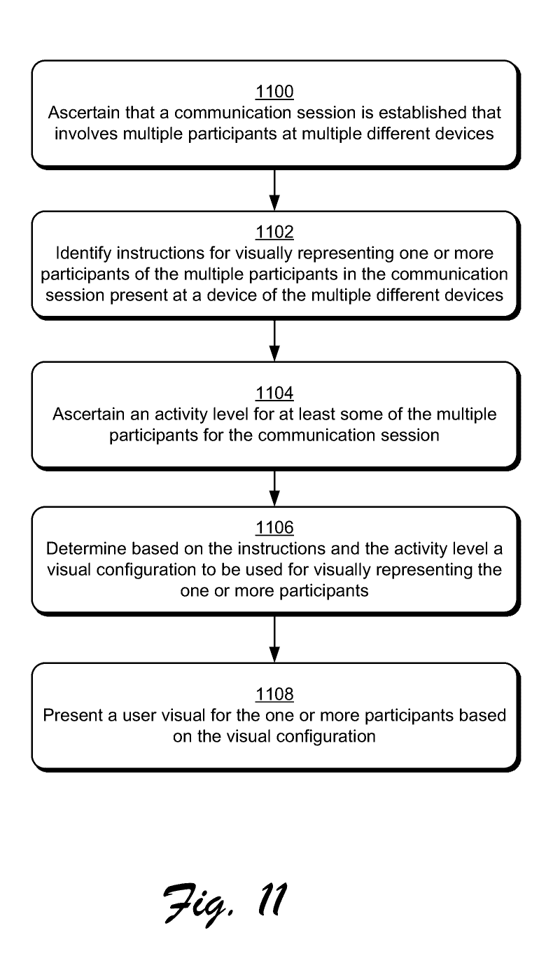

FIG. 11 is a flow diagram that describes steps in a method in accordance with one or more implementations. The method describes an example procedure for presenting a user visual for one or more participants in a communication session in accordance with one or more implementations.

Step 1100 ascertains that a communication session is established that involves multiple participants at multiple different devices. A communication client 110 at a first device, for instance, initiates a communication session with another communication client 110 at a second device, or joins an existing communication session.

Step 1102 identifies instructions for visually representing one or more participants of the multiple participants in the communication session present at a device of the multiple different devices. A communication client 110 at a first device, for instance, receives the instructions from a second device. Generally, the instructions specify a visual configuration to be used to visually represent the one or more participants. The instructions, for example, specify a relative size for a visual for the one or more participants, such as whether the one or more participants are to be displayed via a single user visual, a multiple user visual, and so forth.

Step 1104 ascertains an activity level for at least some of the multiple participants for the communication session. The activity detection module 126, for instance, detects a relative level of activity for participants in the communication session. In at least some implementations, the activity is detected based on voice data detected in media streams from client devices for the different participants. Generally, participants are categorized into more active (“active”) participants, and less active (“passive”) participants. An example way for detecting and characterizing activity levels is detailed below.

Step 1106 determines based on the instructions and the activity level a visual configuration to be used for visually representing the one or more participants. A layout module 122 at a first client device, for instance, utilizes the instructions and the detected activity level to determine a visual configuration for representing one or more participants that are present at a second device involved in the communication session. An example way of determining a visual configuration for participants in a communication session is detailed below.

Step 1108 presents a user visual for the one or more participants based on the visual configuration. The layout module 122, for example, communicates the visual configuration information to the client GUI module 120. Generally, the visual configuration information specifies a size of a visual to be used for representing the one or more participants, and whether the one or more participants are to be visually represented as active participants or passive participants. The client GUI module 120 utilizes the visual configuration information to populate a user visual for the one or more participants to the client GUI 132. Example ways of displaying user visuals based on different participant scenarios are detailed throughout this disclosure.

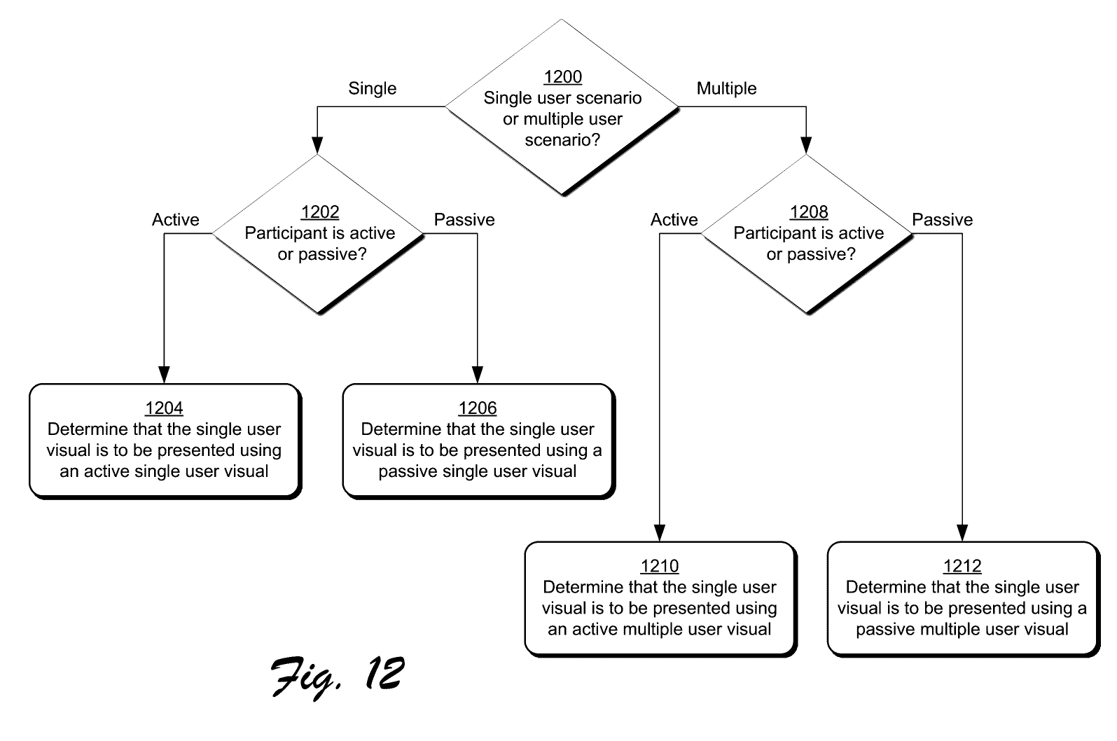

FIG. 12 is a flow diagram that describes steps in a method in accordance with one or more implementations. The method describes an example procedure for determining a visual configuration for one or more participants in a communication session in accordance with one or more implementations. The method, for instance, describes an example procedure for performing step 1106 of the procedure described above with reference to FIG. 11.

Step 1200 ascertains whether a user visual for one or more participants is to be presented according to a single user visual or a multiple user visual. A layout module 122 at a first device, for instance, determines based on instructions received from a second device whether a user visual for a video feed from the second device is to be presented at the first device according to a single user scenario or a multiple user scenario.

If the user visual is to be presented according to a single user visual (“Single”), step 1202 determines whether a participant for the single user visual is active or passive. One example way of determining whether a participant is active or passive is detailed below. If the participant is active (“Active”), step 1204 determines that the single user visual is to be presented using an active single user visual. The single user visual, for instance, is presented as part of an active visual region of the client GUI 132, such as in the standing row 204.

If the participant is passive (“Passive”), step 1206 determines that the single user visual is to be presented as a passive single user visual. For example, the single user visual is presented in a passive user region of the client GUI 132, such as the sitting row 206.

Returning to step 1200, if the user visual is to be presented according to a multiple user visual (“Multiple”), step 1208 determines whether a participant for the multiple user visual is active or passive. If the participant is active (“Active”), step 1210 determines that the multiple user visual is to be presented using an active multiple user visual. The multiple user visual, for instance, is presented as part of an active visual region of the client GUI 132, such as in the standing row 204.

If the participant is passive (“Passive”), step 1212 determines that the multiple user visual is to be presented as a passive multiple user visual. For example, the multiple user visual is presented in a passive user region of the client GUI 132, such as the sitting row 206.

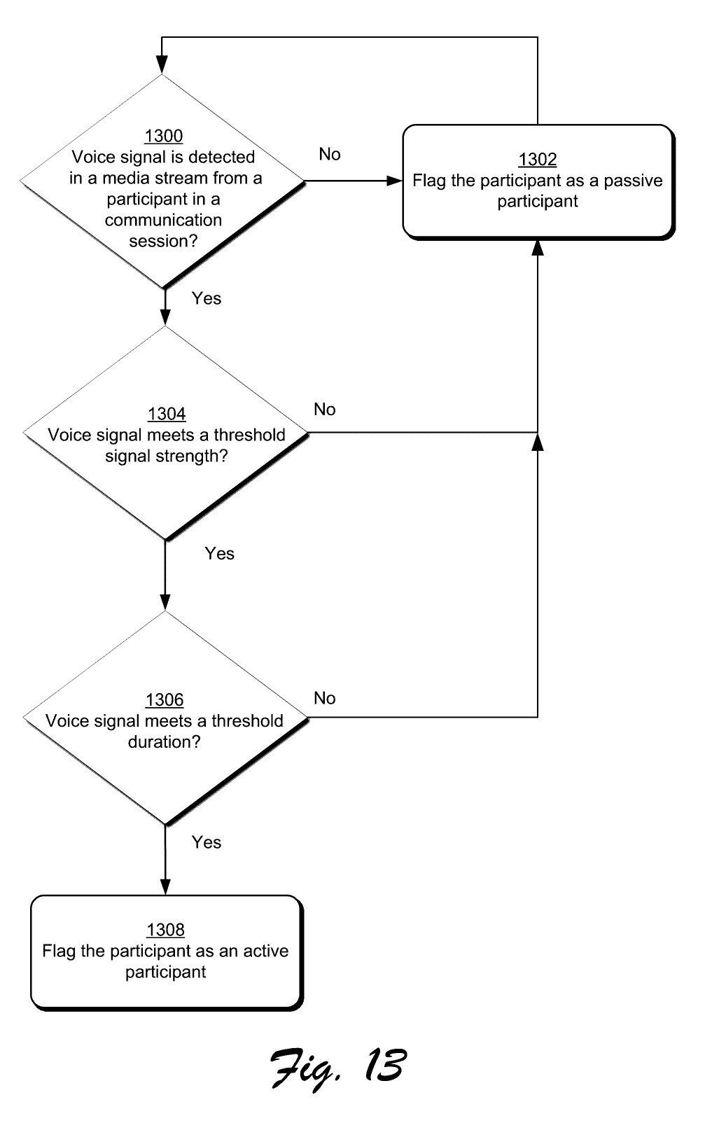

FIG. 13 is a flow diagram that describes steps in a method in accordance with one or more implementations. The method describes an example procedure for ascertaining activity for a participant in a communication session in accordance with one or more implementations. The method, for instance, describes an example procedure for performing step 1104 of the procedure described above with reference to FIG. 11.

Step 1300 ascertains whether voice signal is detected in a media stream from a participant in a communication session. Generally, the media stream is part of a communication session, such as part of a media stream that includes video data and audio data captured at a client device. For instance, the activity detection module 126 for a client device involved in the communication session ascertains whether voice signal is detected in a media stream received from another client device involved in the communication session.

If voice signal is not detected in the media stream (“No”), step 1302 flags the participant as a passive participant. The activity detection module 126, for instance, updates the activity log 128 to indicate that the participant is a passive participant.

If voice signal is detected in the media stream (“Yes”), step 1304 ascertains whether the voice signal meets a threshold signal strength. For instance, the activity detection module 126 compares the voice signal to a threshold signal strength. The threshold signal strength may be specified in various ways, such as a threshold volume level, a threshold minimum signal-to-strength value, and so forth.

If the voice signal does not meet the threshold signal strength (“No”), the process returns to step 1302 and the participant is flagged as a passive participant.

If the voice signal meets the threshold signal strength (“Yes”), step 1306 ascertains whether the voice signal meets a threshold duration. The threshold duration may be specified in various ways, such as in milliseconds, seconds, and so forth. If the voice signal does not meet the threshold duration (“No”), the process returns to step 1306 and the participant is flagged as a passive participant.

If the voice signal meets the threshold duration (“Yes”), step 1310 flags the participant as an active participant. The activity detection module 126, for instance, updates the activity log 128 to categorize the participant as an active participant.

The procedure may be performed continuously and/or periodically during a communication session to ascertain whether a participant is active or passive. For instance, if a participant is flagged as a passive participant, a media stream from the participant is continuously monitored for voice data. Thus, if the participant subsequently begins speaking during the communication session such that voice data is detected that meets the specified thresholds, the participant may be reflagged as an active participant. Further, if an active participant ceases speaking during the communication session, the active participant may be flagged as a least active participant and/or reflagged as a passive participant.

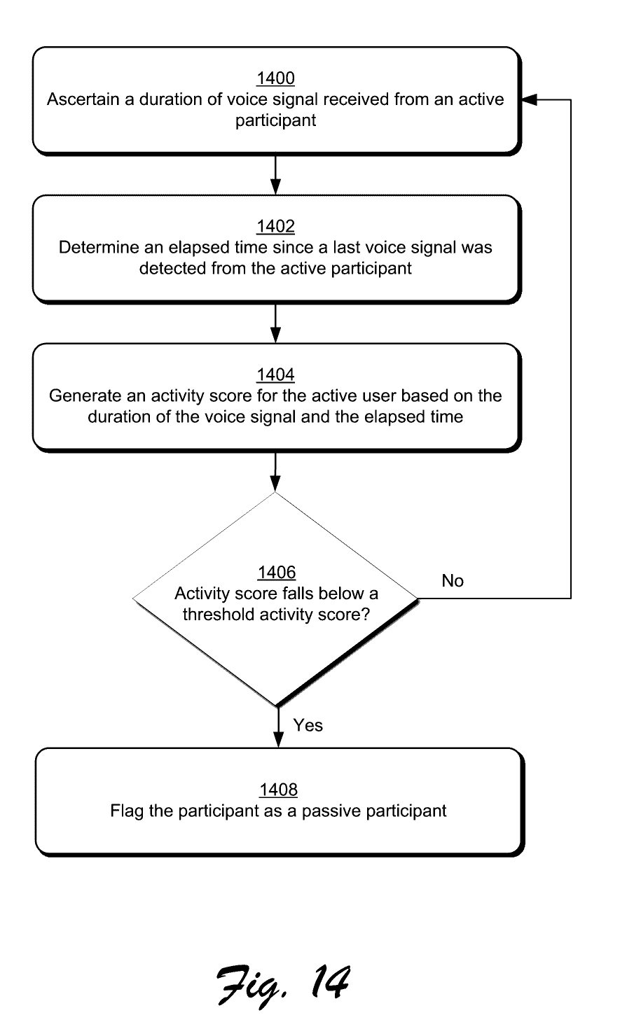

FIG. 14 is a flow diagram that describes steps in a method in accordance with one or more implementations. The method describes an example procedure for ascertaining an activity level for an active participant in a communication session in accordance with one or more implementations.

Step 1400 ascertains a duration of voice signal received from an active participant. The duration, for instance, may be determined based on a single voice event, such as a duration of a single uninterrupted stream of voice signal received from the active participant. Alternatively or additionally, the duration may be determined based on multiple different discrete voice events from the participant over a specified period of time.

Step 1402 determines an elapsed time since a last voice signal was detected from the active participant. The last voice signal, for instance, corresponds to a voice signal from the active participant that meets a threshold signal strength and/or a threshold duration. The elapsed time may be specified in various ways, such in milliseconds, seconds, minutes, and so forth.

Step 1404 generates an activity score for the active user based on the duration of the voice signal and the elapsed time. For example, when a participant is flagged as an active participant such as described above, the participant is given a default activity score. The activity score for the participant is then adjustable based on whether the participant is more or less active. For instance, the activity score is increased in response to detecting longer duration of voice signal from the participant and/or in response to a shorter elapsed time since a most recent voice signal from the participant. Conversely, the activity score is decreased in response to detecting shorter duration of voice signal from the participant and/or in response to a longer elapsed time since a most recent voice signal from the participant. Thus, a participant that contributes longer durations of voice input and more frequent voice input to a communication session has a higher activity score than a participant that contributes shorter durations of voice input and less frequent voice input to the communication session. In at least some implementations, an active participant with a lower activity score than a different active participant is considered a less active participant than the different active participant.

Step 1406 ascertains whether the activity score falls below a threshold activity score. If the activity score falls below a threshold activity score (“Yes”), step 1408 flags the participant as a passive participant. The activity detection module 126, for instance, updates the activity log 128 to indicate that the participant is a passive participant. In at least some implementations, flagging the participant as a passive participant causes a visual representation of the participant to be transitioned (e.g., demoted) from an active region of the client GUI 132 (e.g., the standing row 204) to a passive region of the client GUI 132, e.g., the sitting row 206.

If the activity score does not fall below the threshold activity score (“No”), the procedure returns to step 1400. For instance, an activity score for an active participant may be continuously and/or periodically adjusted to account for changes in activity for the participant. Thus, techniques described herein can be employed to dynamically evaluate activity levels during a communication session to ascertain whether a participant is active or passive, such as described above with reference to FIG. 13. Further, an active participant may be dynamically evaluated to identify more active and less active participants, and to reflag an active participant as a passive participant if the participant's activity level falls below a threshold.

According to implementations discussed herein, the procedures described above are automatically, periodically, and/or continuously performed during a communication session to ascertain visual configurations to be used for representing participants in a communication session. For instance, after a user initiates and or accepts an invitation to participate in a communication session, the procedures described above are automatically initiated without any further user interaction.

Having discussed some example procedures, consider now a discussion of an example system and device in accordance with one or more embodiments.

Example System and Device

FIG. 15 illustrates an example system generally at 1500 that includes an example computing device 1502 that is representative of one or more computing systems and/or devices that may implement various techniques described herein. For example, the client device 102 and/or the communication service 118 discussed above with reference to FIG. 1 can be embodied as the computing device 1502. The computing device 1502 may be, for example, a server of a service provider, a device associated with the client (e.g., a client device), an on-chip system, and/or any other suitable computing device or computing system.

The example computing device 1502 as illustrated includes a processing system 1504, one or more computer-readable media 1506, and one or more Input/Output (I/O) Interfaces 1508 that are communicatively coupled, one to another. Although not shown, the computing device 1502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware element 1510 that may be configured as processors, functional blocks, and so forth. This may include implementation in hardware as an application specific integrated circuit or other logic device formed using one or more semiconductors. The hardware elements 1510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1506 is illustrated as including memory/storage 1512. The memory/storage 1512 represents memory/storage capacity associated with one or more computer-readable media. The memory/storage 1512 may include volatile media (such as random access memory (RAM)) and/or nonvolatile media (such as read only memory (ROM), Flash memory, optical disks, magnetic disks, and so forth). The memory/storage 1512 may include fixed media (e.g., RAM, ROM, a fixed hard drive, and so on) as well as removable media (e.g., Flash memory, a removable hard drive, an optical disc, and so forth). The computer-readable media 1506 may be configured in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1502. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1510 and computer-readable media 1506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1510. The computing device 1502 may be configured to implement particular instructions and/or functions corresponding to the software and/or hardware modules. Accordingly, implementation of modules that are executable by the computing device 1502 as software may be achieved at least partially in hardware, e.g., through use of computer-readable storage media and/or hardware elements 1510 of the processing system. The instructions and/or functions may be executable/operable by one or more articles of manufacture (for example, one or more computing devices 1502 and/or processing systems 1504) to implement techniques, modules, and examples described herein.

As further illustrated in FIG. 15, the example system 1500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1502 may assume a variety of different configurations, such as for computer 1514, mobile 1516, and television 1518 uses. Each of these configurations includes devices that may have generally different constructs and capabilities, and thus the computing device 1502 may be configured according to one or more of the different device classes. For instance, the computing device 1502 may be implemented as the computer 1514 class of a device that includes a personal computer, desktop computer, a multi-screen computer, laptop computer, netbook, and so on.

The computing device 1502 may also be implemented as the mobile 1516 class of device that includes mobile devices, such as a mobile phone, portable music player, portable gaming device, a tablet computer, a wearable device, a multi-screen computer, and so on. The computing device 1502 may also be implemented as the television 1518 class of device that includes devices having or connected to generally larger screens in casual viewing environments. These devices include televisions, set-top boxes, gaming consoles, and so on.

The techniques described herein may be supported by these various configurations of the computing device 1502 and are not limited to the specific examples of the techniques described herein. For example, functionalities discussed with reference to the communication client 110 and/or the communication service 118 may be implemented all or in part through use of a distributed system, such as over a “cloud” 1520 via a platform 1522 as described below.

The cloud 1520 includes and/or is representative of a platform 1522 for resources 1524. The platform 1522 abstracts underlying functionality of hardware (e.g., servers) and software resources of the cloud 1520. The resources 1524 may include applications and/or data that can be utilized while computer processing is executed on servers that are remote from the computing device 1502. Resources 1524 can also include services provided over the Internet and/or through a subscriber network, such as a cellular or Wi-Fi network.

The platform 1522 may abstract resources and functions to connect the computing device 1502 with other computing devices. The platform 1522 may also serve to abstract scaling of resources to provide a corresponding level of scale to encountered demand for the resources 1524 that are implemented via the platform 1522. Accordingly, in an interconnected device embodiment, implementation of functionality described herein may be distributed throughout the system 1500. For example, the functionality may be implemented in part on the computing device 1502 as well as via the platform 1522 that abstracts the functionality of the cloud 1520.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for specifying a visual configuration for visually representing one or more participants in a communication session, the system including: at least one processor; and one or more computer-readable storage media including instructions stored thereon that, responsive to execution by the at least one processor, cause the system perform operations including: ascertaining that a communication session is established between a first device and a second device; detecting via video captured at the first device a participant count for one or more participants for the communication session present at the first device; determining based on the participant count a visual configuration to be used for visually representing the one or more participants; and communicating an instruction to the second device specifying the visual configuration to be used for visually representing the one or more participants at the second device.

### Example 2

A system as described in example 1, wherein said detecting is based on detecting one or more faces in the video captured at the first device.

### Example 3

A system as described in one or more of examples 1 or 2, wherein said detecting includes detecting a participant count of one participant based on detecting a single participant present at the first device, and wherein said determining includes determining a single user visual configuration to be used for visually representing the single participant.

### Example 4

A system as described in one or more of examples 1-3, wherein said detecting includes detecting a participant count of more than one participant based on detecting multiple participants present at the first device, and wherein said determining includes determining a multiple user visual configuration to be used for visually representing the multiple participants.

### Example 5

A system as described in one or more of examples 1-4, wherein the operations further include: detecting a change in the participant count based on a change in number of the one or more participants; determining based on the change in the participant count a further visual configuration to be used for visually representing the one or more participants; and communicating a further instruction to the second device specifying the further visual configuration to be used for visually representing the one or more participants at the second device.

### Example 6

A system as described in one or more of examples 1-5, wherein said detecting includes detecting a participant count of one participant based on detecting a single participant present at the first device, said determining includes determining a single user visual configuration to be used for visually representing the single participant, the operations further including: detecting via the video captured at the first device and subsequent to said communicating the instruction that at least one additional participant is present with the single participant at the first device; determining based on detecting the additional participant a further visual configuration to be used for representing the single participant and the at least one additional participant; and communicating a further instruction to the second device specifying the further visual configuration for representing the single participant and the at least one additional participant.

### Example 7

A system as described in one or more of examples 1-6, wherein said detecting includes detecting a participant count of more than one participant based on detecting multiple participants present at the first device, said determining includes determining a multiple user visual configuration to be used for visually representing the multiple participants, the operations further including: detecting via the video captured at the first device and subsequent to said communicating the instruction that one or more participants of the multiple participants are no longer present at the first device such that a single participant is detected at the first device; determining based on detecting the single participant a further visual configuration to be used for representing the single participant; and communicating a further instruction to the second device specifying the further visual configuration for representing the single participant.

### Example 8

A system as described in one or more of examples 1-7, wherein said detecting includes detecting a participant count of one participant based on detecting a single participant present at the first device, said determining includes determining a single user visual configuration to be used for visually representing the single participant, the operations further including: detecting subsequent to said communicating the instruction that a share mode is activated at the first device; and determining based on the share mode a further visual configuration to be used for representing the single participant in the share mode; and communicating a further instruction to the second device specifying the further visual configuration for representing the single participant in the share mode.

### Example 9

A computer-implemented method for presenting a user visual for one or more participants in a communication session, the method including: ascertaining at a first device that a communication session is established that involves multiple participants at multiple different devices; identifying at the first device instructions for visually representing one or more participants of the multiple participants in the communication session present at a second device of the multiple different devices; ascertaining at the first device an activity level for at least some of the multiple participants for the communication session; determining based on the instructions and the activity level a visual configuration to be used at the first device for visually representing the one or more participants present at the second device; and presenting at the first device a user visual for the one or more participants based on the visual configuration.

### Example 10

A method as described in example 9, wherein said identifying includes receiving the instructions from the second device.

### Example 11

A method as described in one or more of examples 9 or 10, wherein said ascertaining the activity level is based on voice signal detected for the at least some of the multiple participants.

### Example 12

A method as described in one or more of examples 9-11, wherein the instructions specify a visual size to be used to visually represent the one or more participants, and said determining includes determining the visual configuration based the visual size and the activity level.

### Example 13

A method as described in one or more of examples 9-12, wherein the instructions specify that the one more participants are to be visually represented using a single user visual, said ascertaining the activity level includes ascertaining that the one or more participants are active in the communication session, said determining includes determining that the one or more participants are to be visually represented according to an active single user visual configuration, and said presenting includes presenting the user visual based on the active single user visual configuration.

### Example 14

A method as described in one or more of examples 9-13, wherein the instructions specify that the one more participants are to be visually represented using a multiple user visual, said ascertaining the activity level includes ascertaining that the one or more participants are active in the communication session, said determining includes determining that the one or more participants are to be visually represented according to an active multiple user visual configuration, and said presenting includes presenting the user visual based on the active multiple user visual configuration.

### Example 15

A method as described in one or more of examples 9-14, wherein the instructions specify that the one more participants are to be visually represented using a single user visual, said ascertaining the activity level includes ascertaining that the one or more participants are passive in the communication session, said determining includes determining that the one or more participants are to be visually represented according to a passive single user visual configuration, and said presenting includes presenting the user visual based on the passive single user visual configuration.

### Example 16

A method as described in one or more of examples 9-15, wherein said presenting includes presenting the user visual based on an active single user visual configuration, the method further including: receiving further instructions for visually representing the one or more participants present at the second device, the further instructions indicating a change in a number of the one or more participants; determining based on the further instructions and the activity level a further visual configuration to be used at the first device for visually representing the one or more participants present at the second device; and presenting a different user visual for the one or more participants based on the further visual configuration.

### Example 17

A method as described in one or more of examples 9-16, wherein: said ascertaining the activity level includes ascertaining the a first participant of the multiple participants is more active than a second participant of the multiple participants; and said presenting includes presenting a user visual for the first participant in an active participant region of a graphical user interface (GUI) displayed at the first device for the communication session, and presenting a user visual for the second participant in a passive participant region of the GUI.

### Example 18

A computer-implemented method for determining a visual configuration for visually representing one or more participants in a communication session, the method including: ascertaining that a communication session is established that involves participants at a first device and a second device; identifying instructions for visually representing one or more of the participants in the communication session present at the second device; ascertaining an activity level for at least some of the participants for the communication session; and determining based on the instructions and the activity level a visual configuration to be used at the first device for visually representing the one or more participants present at the second device.

### Example 19

A method as described in example 18, wherein said identifying includes receiving the instructions from the second device, and wherein the method further includes communicating the visual configuration to the first device.

### Example 20

A method as described in one or more of examples 18 or 19, wherein the instructions specify that the one or more participants are to be visually represented according to a multiple user scenario, said ascertaining the activity level includes ascertaining that the one or more participants are active in the communication session, and said determining includes determining that the one or more participants are to be represented at the second device via an active multiple user visual.

### CONCLUSION

Techniques for visual configuration for communication session participants are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
ascertaining that a communication session is established between a first device and a second device;
detecting via video captured at the first device a participant count for one or more participants for the communication session present at the first device;
determining based on the participant count a visual configuration to be used for visually representing the one or more participants; and
communicating an instruction to the second device specifying the visual configuration to be used for visually representing the one or more participants at the second device.

2. A system as recited in claim 1, wherein said detecting is based on detecting one or more faces in the video captured at the first device.

3. A system as recited in claim 1, wherein said detecting comprises detecting a participant count of one participant based on detecting a single participant present at the first device, and wherein said determining comprises determining a single user visual configuration to be used for visually representing the single participant.

4. A system as recited in claim 1, wherein said detecting comprises detecting a participant count of more than one participant based on detecting multiple participants present at the first device, and wherein said determining comprises determining a multiple user visual configuration to be used for visually representing the multiple participants.

5. A system as recited in claim 1, wherein the operations further include:
detecting a change in the participant count based on a change in number of the one or more participants;
determining based on the change in the participant count a further visual configuration to be used for visually representing the one or more participants; and
communicating a further instruction to the second device specifying the further visual configuration to be used for visually representing the one or more participants at the second device.

6. A system as recited in claim 1, wherein said detecting comprises detecting a participant count of one participant based on detecting a single participant present at the first device, said determining comprises determining a single user visual configuration to be used for visually representing the single participant, the operations further including:
detecting via the video captured at the first device and subsequent to said communicating the instruction that at least one additional participant is present with the single participant at the first device;
determining based on detecting the additional participant a further visual configuration to be used for representing the single participant and the at least one additional participant; and
communicating a further instruction to the second device specifying the further visual configuration for representing the single participant and the at least one additional participant.

7. A system as recited in claim 1, wherein said detecting comprises detecting a participant count of more than one participant based on detecting multiple participants present at the first device, said determining comprises determining a multiple user visual configuration to be used for visually representing the multiple participants, the operations further including:
detecting via the video captured at the first device and subsequent to said communicating the instruction that one or more participants of the multiple participants are no longer present at the first device such that a single participant is detected at the first device;
determining based on detecting the single participant a further visual configuration to be used for representing the single participant; and
communicating a further instruction to the second device specifying the further visual configuration for representing the single participant.

8. A system as recited in claim 1, wherein said detecting comprises detecting a participant count of one participant based on detecting a single participant present at the first device, said determining comprises determining a single user visual configuration to be used for visually representing the single participant, the operations further including:
detecting subsequent to said communicating the instruction that a share mode is activated at the first device; and
determining based on the share mode a further visual configuration to be used for representing the single participant in the share mode; and
communicating a further instruction to the second device specifying the further visual configuration for representing the single participant in the share mode.

9. A computer-implemented method, comprising:
ascertaining at a first device that a communication session is established that involves multiple participants at multiple different devices;
identifying at the first device instructions for visually representing one or more participants of the multiple participants in the communication session present at a second device of the multiple different devices;
ascertaining at the first device an activity level for at least some of the multiple participants for the communication session;
determining based on the instructions and the activity level a visual configuration to be used at the first device for visually representing the one or more participants present at the second device; and
presenting at the first device a user visual for the one or more participants based on the visual configuration.

10. A method as described in claim 9, wherein said identifying comprises receiving the instructions from the second device.

11. A method as described in claim 9, wherein said ascertaining the activity level is based on voice signal detected for the at least some of the multiple participants.

12. A method as described in claim 9, wherein the instructions specify a visual size to be used to visually represent the one or more participants, and said determining comprises determining the visual configuration based the visual size and the activity level.

13. A method as described in claim 9, wherein the instructions specify that the one more participants are to be visually represented using a single user visual, said ascertaining the activity level comprises ascertaining that the one or more participants are active in the communication session, said determining comprises determining that the one or more participants are to be visually represented according to an active single user visual configuration, and said presenting comprises presenting the user visual based on the active single user visual configuration.

14. A method as described in claim 9, wherein the instructions specify that the one more participants are to be visually represented using a multiple user visual, said ascertaining the activity level comprises ascertaining that the one or more participants are active in the communication session, said determining comprises determining that the one or more participants are to be visually represented according to an active multiple user visual configuration, and said presenting comprises presenting the user visual based on the active multiple user visual configuration.

15. A method as described in claim 9, wherein the instructions specify that the one more participants are to be visually represented using a single user visual, said ascertaining the activity level comprises ascertaining that the one or more participants are passive in the communication session, said determining comprises determining that the one or more participants are to be visually represented according to a passive single user visual configuration, and said presenting comprises presenting the user visual based on the passive single user visual configuration.

16. A method as described in claim 9, wherein said presenting comprises presenting the user visual based on an active single user visual configuration, the method further comprising:
receiving further instructions for visually representing the one or more participants present at the second device, the further instructions indicating a change in a number of the one or more participants;
determining based on the further instructions and the activity level a further visual configuration to be used at the first device for visually representing the one or more participants present at the second device; and
presenting a different user visual for the one or more participants based on the further visual configuration.

17. A method as described in claim 9, wherein:
said ascertaining the activity level comprises ascertaining the a first participant of the multiple participants is more active than a second participant of the multiple participants; and
said presenting comprises presenting a user visual for the first participant in an active participant region of a graphical user interface (GUI) displayed at the first device for the communication session, and presenting a user visual for the second participant in a passive participant region of the GUI.

18. A computer-implemented method, comprising:
ascertaining that a communication session is established that involves participants at a first device and a second device;
identifying instructions for visually representing one or more of the participants in the communication session present at the second device;
ascertaining an activity level for at least some of the participants for the communication session; and
determining based on the instructions and the activity level a visual configuration to be used at the first device for visually representing the one or more participants present at the second device.

19. A method as described in claim 18, wherein said identifying comprises receiving the instructions from the second device, and wherein the method further comprises communicating the visual configuration to the first device.

20. A method as described in claim 18, wherein the instructions specify that the one or more participants are to be visually represented according to a multiple user scenario, said ascertaining the activity level comprises ascertaining that the one or more participants are active in the communication session, and said determining comprises determining that the one or more participants are to be represented at the second device via an active multiple user visual.
